(19) United States
(12) Patent Application Publication
(10) Pub. No.: US 2026/0039042 A1
(43) Pub. Date: Feb. 5, 2026

(54) CORD ASSEMBLY AND ASSEMBLY METHOD USING THE SAME

(71) Applicant: DELTA ELECTRONICS, INC., Taoyuan City (TW)

(72) Inventors: Chun-Hua CHEN, Taoyuan City (TW); Ko-Kuei CHEN, Taoyuan City (TW); Hung Chuan CHEN, Taoyuan City (TW); Ming-Chi LIN, Taoyuan City (TW); Wei-Hung LEE, Taoyuan City (TW)

(21) Appl. No.: 18/885,856

(22) Filed: Sep. 16, 2024

(30) Foreign Application Priority Data
Jul. 30, 2024 (CN) 202411026224.X

(51) Int. Cl. H01R 12/71; H01R 11/05; H01R 13/422; H01R 13/504; H01R 13/56; H01R 43/02

(52) U.S. Cl. CPC H01R 12/714; H01R 11/05; H01R 13/4223; H01R 13/504; H01R 13/562; H01R 43/0214

(57) ABSTRACT

A cord assembly includes a conductive cord, a terminal component, and a base. The terminal component includes a crimping portion and an elastic piece structure. The crimping portion is crimped to an end of the conductive cord. The elastic piece structure includes a first extending portion and a second extending portion. The first extending portion is connected to the crimping portion and extends away from the end of the conductive cord. The second extending portion is connected to an end of the first extending portion away from the crimping portion, and is folded relative to the first extending portion. The base has an engaging slot. The first extending portion is engaged in the engaging slot. The second extending portion protrudes outside the engaging slot.

### CROSS-REFERENCE TO RELATED APPLICATION

This application claims priority to China Application Serial Number 202411026224.X, filed Jul. 30, 2024, which is herein incorporated by reference.

### BACKGROUND

### Technical Field

The present disclosure relates to a cord assembly and an assembly method using the same.

### Description of Related Art

A power supply is an electronic device that converts alternating current (AC) into direct current (DC). Direct current is used to power a variety of electronic devices, including computers, televisions, and cell phones.

An existing DC power cord is crimped with a connector at the power supply end, and then manually assembled with a terminal base on the printed circuit board of the power supply. The terminal base must be pre-installed on the printed circuit board together with other parts using surface mount technology (SMT) during the manufacturing process of the printed circuit board. However, this assembly method requires a large number of terminals and is labor-intensive.

Accordingly, how to provide a cord assembly and an assembly method using the same to solve the aforementioned problems becomes an important issue to be solved by those in the industry.

### SUMMARY

A purpose of the disclosure is to provide a cord assembly and an assembly method using the same that can efficiently solve the aforementioned problems.

In order to achieve the above purpose, according to an embodiment of the disclosure, a cord assembly includes a conductive cord, a terminal component, and a base. The terminal component includes a crimping portion and an elastic piece structure. The crimping portion is crimped to an end of the conductive cord. The elastic piece structure includes a first extending portion and a second extending portion. The first extending portion is connected to the crimping portion and extends away from the end of the conductive cord. The second extending portion is connected to an end of the first extending portion away from the crimping portion and folded relative to the first extending portion. The base has an engaging slot. The first extending portion is engaged in the engaging slot. The second extending portion protrudes outside the engaging slot.

In one or more embodiments of the disclosure, an edge of the first extending portion is slidably engaged with an inner edge of the engaging slot.

In one or more embodiments of the disclosure, the engaging slot has a side opening and a top opening. The first extending portion is configured to insert into the engaging slot from the side opening. The second extending portion is configured to protrude outside the engaging slot from the top opening.

In one or more embodiments of the disclosure, a width of the side opening is greater than a width of the top opening.

In one or more embodiments of the disclosure, the first extending portion is configured to insert into the engaging slot in an insertion direction. The width of the side opening and the width of the top opening are measured in a lateral direction perpendicular to the insertion direction.

In one or more embodiments of the disclosure, a width of the first extending portion is greater than a width of the second extending portion.

In one or more embodiments of the disclosure, the cord assembly further includes a cord sheath. The cord sheath includes an inner mold and an extending structure. The inner mold covers a part of the conductive cord. The extending structure is connected to the inner mold and covers another part of the conductive cord extending between the inner mold and the terminal component and a part of the base.

In one or more embodiments of the disclosure, the cord sheath further includes an outer mold. The outer mold covers a part of the inner mold and forms a groove with the inner mold.

In one or more embodiments of the disclosure, the inner mold and the extending structure include a first material. The outer mold includes a second material. A hardness of the first material is greater than a hardness of the second material.

In order to achieve the above purpose, according to an embodiment of the disclosure, an assembly method for assembling a cord assembly into a housing is provided. The cord assembly includes a conductive cord and a terminal component connected to an end of the conductive cord. The terminal component includes an elastic piece structure. The assembly method includes: making the end of the conductive cord extend into the housing to make the elastic piece structure be located in the housing; placing a circuit board in the housing to make a welding material on the circuit board contact the elastic piece structure; and performing a non-contact welding process to weld the elastic piece structure to the welding material.

In one or more embodiments of the disclosure, the non-contact welding process is an electromagnetic induction welding process.

In one or more embodiments of the disclosure, the step of performing the non-contact welding process includes: using an induction coil to perform the electromagnetic induction welding process on the welding material and the elastic piece structure that are in contact with each other through the housing.

In one or more embodiments of the disclosure, the step of performing the non-contact welding process includes: using an induction coil to perform an electromagnetic induction welding process on the welding material and the elastic piece structure on a side of the circuit board away from the housing.

In one or more embodiments of the disclosure, the cord assembly further includes a cord sheath. The cord sheath covers the conductive cord and has a groove. The housing includes a sidewall. The step of making the end of the conductive cord extend into the housing includes: placing the cord sheath on the sidewall so that a part of the sidewall is engaged in the groove.

In one or more embodiments of the disclosure, the cord sheath includes an extending structure. An edge of the circuit board has a notch. The step of making the end of the conductive cord extend into the housing makes the extending structure be located in the housing. The step of placing the circuit board in the housing makes the extending structure enter the notch.

To sum up, in the cord assembly and the assembly method using the same of the present disclosure, by crimping the crimping portion of the terminal component to an end of the conductive cord and engaging the terminal component and the base with each other, the terminal component can become an electrical connection structure that is firmly connected to the end of the conductive cord. By making the extending structure of the cord sheath cover the conductive cord and a part of the base and making the cord sheath have a specific shape, the terminal component can be firmly positioned at a specific position in the housing after the cord assembly and the housing are assembled. The positioning facilitates contact between the terminal component and the welding material on the circuit board after subsequent assembly of the circuit board. Finally, a non-contact welding process is used to weld the elastic piece structure and the welding material together, which can reduce the use of components and meet the needs of automated assembly.

The above is only used to describe the problems to be solved by the present disclosure, technical solutions to solve the problems and their effects, and so on. Specific details of the present disclosure will be described in the following embodiments with reference to relevant drawings.

### BRIEF DESCRIPTION OF THE DRAWINGS

In order to make the above and other purposes, features, advantages, and embodiments of the present disclosure easier to understand, the accompanying drawings are provided and described as follows.

FIG. 1 is a partial perspective view of a cord assembly according to an embodiment of the present disclosure;

FIG. 2 is a partial perspective view of some components of the cord assembly in FIG. 1;

FIG. 3 is another partial perspective view of some components of the cord assembly in FIG. 1;

FIG. 4 is a perspective view of a base of the cord assembly in FIG. 1;

FIG. 5 is another partial perspective view of some components of the cord assembly in FIG. 1;

FIG. 6 is a flowchart of an assembly method according to an embodiment of the present disclosure;

FIG. 7 is a schematic diagram of an intermediate stage of the assembly method according to an embodiment of the present disclosure;

FIG. 8 is a schematic diagram of another intermediate stage of the assembly method according to an embodiment of the present disclosure;

FIG. 9 is a side view of the structure in FIG. 8, in which a housing and a circuit board are presented in cross-section; and

FIG. 10 is a schematic diagram of an induction coil according to an embodiment of the present disclosure.

### DETAILED DESCRIPTION

A plurality of embodiments of the present disclosure will be described below with reference to the accompanying drawings. For the sake of clarity, many practical details will be described together in the following description. However, it should be understood that these practical details should not be used to limit the present disclosure. That is to say, in some embodiments of the present disclosure, these practical details are not necessary. In addition, for the sake of simplifying the accompanying drawings, some commonly used structures and components are illustrated in the accompanying drawings in a simple schematic manner.

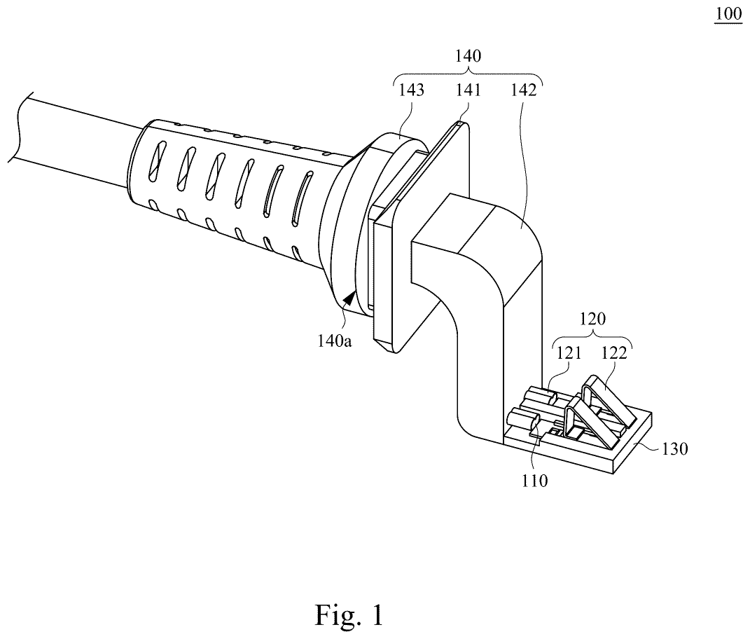

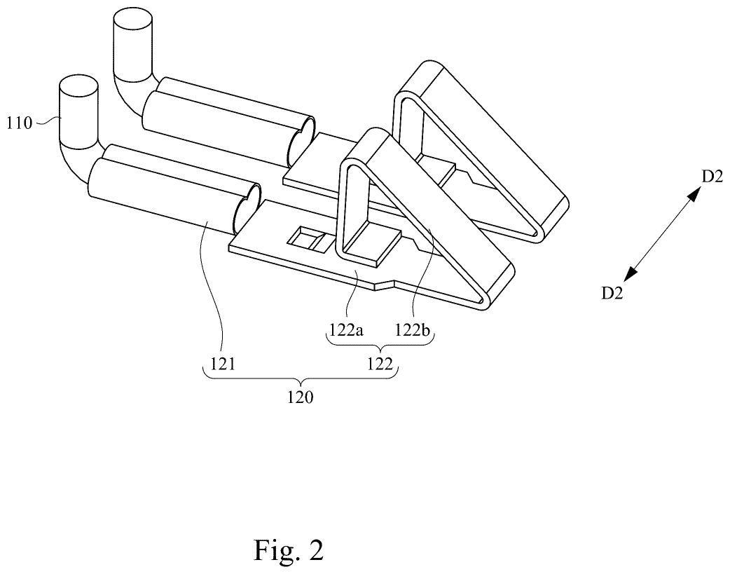

Reference is made to FIG. 1 and FIG. 2. FIG. 1 is a partial perspective view of a cord assembly 100 according to an embodiment of the present disclosure. FIG. 2 is a partial perspective view of some components of the cord assembly 100 in FIG. 1. As shown in FIG. 1 and FIG. 2, the cord assembly 100 includes a conductive cord 110 and a terminal component 120. In some embodiments, the conductive cord 110 is a DC power cord of a power supply, but the present disclosure is not limited thereto. The terminal component 120 includes a crimping portion 121 and an elastic piece structure 122. The crimping portion 121 is crimped to an end of the conductive cord 110. Specifically, before crimping, the crimping portion 121 is a flat metal piece. At this time, the conductive cord 110 can be placed on the flat crimping portion 121 first. During crimping, opposite sides of the crimping portion 121 can be bent upward to cover the conductive cord 110, and then pressed toward the conductive cord 110 to crimp the crimping portion 121 to the conductive cord 110. For example, cross-sections of the crimping portion 121 and the conductive cord 110 after crimping are substantially approximately heart-shaped, but the present disclosure is not limited thereto.

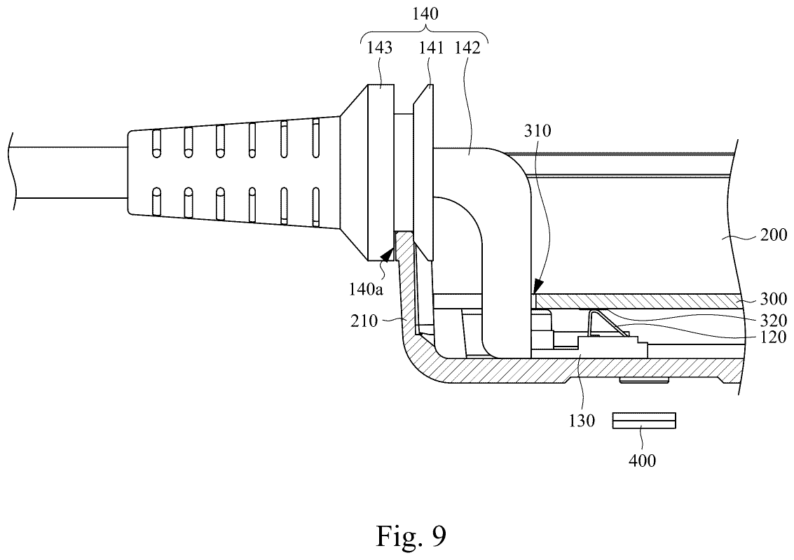

As shown in FIG. 2, the elastic piece structure 122 includes a first extending portion 122a and a second extending portion 122b. The first extending portion 122a is connected to the crimping portion 121 and extends away from the end of the conductive cord 110. The second extending portion 122b is connected to an end of the first extending portion 122a away from the crimping portion 121 and folded relative to the first extending portion 122a. In this way, the terminal component 120 can become an electrical connection structure connected to one end of the conductive cord 110, and can utilize its own elasticity to provide a buffering effect when it comes into contact with other objects (such as a circuit board 300 shown in FIG. 9).

In some embodiments, the terminal component 120 may be made of a metal sheet through, for example, a stamping process to form the contours of various parts, and then, for example, through a bending process to form a specific three-dimensional shape.

In some embodiments, an included angle between the first extending portion 122a and the second extending portion 122b is less than 90 degrees, but the present disclosure is not limited thereto.

In some embodiments, an end of the second extending portion 122b away from the first extending portion 122a may continue to be bent one or more times in a forward direction, so that the first extending portion 122a and the second extending portion 122b form, for example, a triangular shape, but the present disclosure is not limited thereto.

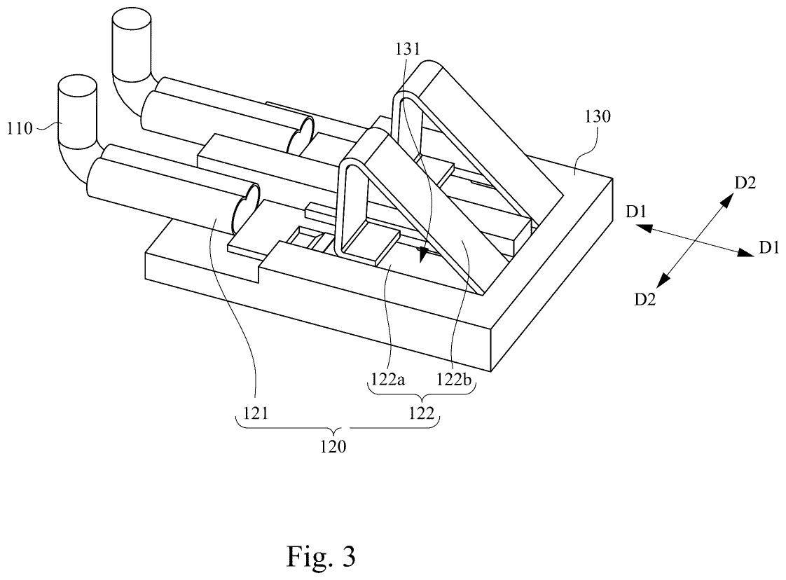

Reference is made to FIG. 3. FIG. 3 is another partial perspective view of some components of the cord assembly 100 in FIG. 1. As shown in FIG. 3, the cord assembly 100 further includes a base 130. The base 130 has an engaging slot 131. The first extending portion 122a of the elastic piece structure 122 is engaged in the engaging slot 131. The second extending portion 122b of the elastic piece structure 122 protrudes outside the engaging slot 131. In addition, at least a part of the crimping portion 121 of the elastic piece structure 122 is carried on the base 130. In this way, the base 130 can make the terminal component 120 become an electrical connection structure that is firmly connected to one end of the conductive cord 110.

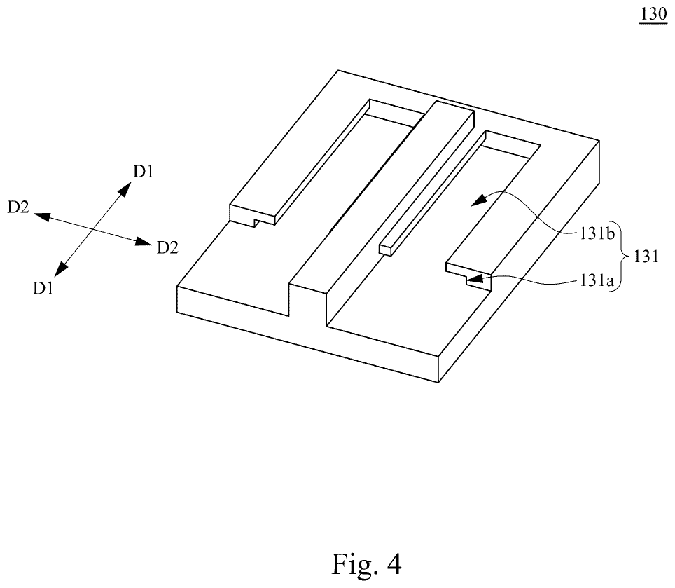

Reference is made to FIG. 4. FIG. 4 is a perspective view of the base 130 of the cord assembly in FIG. 1. As shown in FIG. 2 to FIG. 4, an edge of the first extending portion 122a is slidably engaged with an inner edge of the engaging slot 131. In other words, in the present embodiment, the engaging slot 131 is a sliding slot.

Furthermore, as shown in FIG. 4, the engaging slot 131 has a side opening 131a and a top opening 131b. The side opening 131a communicates with the top opening 131b. The first extending portion 122a of the terminal component 120 is configured to insert into the engaging slot 131 from the side opening 131a. The second extending portion 122b of the terminal component 120 is configured to protrude outside the engaging slot 131 from the top opening 131b. It should be noted that, in order to make the edge of the first extending portion 122a slidably engage the inner edge of the engagement slot 131, and to make the second extending portion 122b protrude outside the engagement slot 131 from the top opening 131b, it can be designed in such a way that a width of the side opening 131a of the engaging slot 131 is greater than a width of the top opening 131b (the widths in a lateral direction D2 perpendicular to an insertion direction D1). Correspondingly, as shown in FIG. 2, a width of the first extending portion 122a must be greater than a width of the second extending portion 122b (the widths in the aforementioned lateral direction D2).

In some embodiments, the engaging slot 131 may also be an engaging structure other than the sliding slot. For example, the engaging structure may be a structure in which the first extending portion 122a is simply fixed using a buckling method.

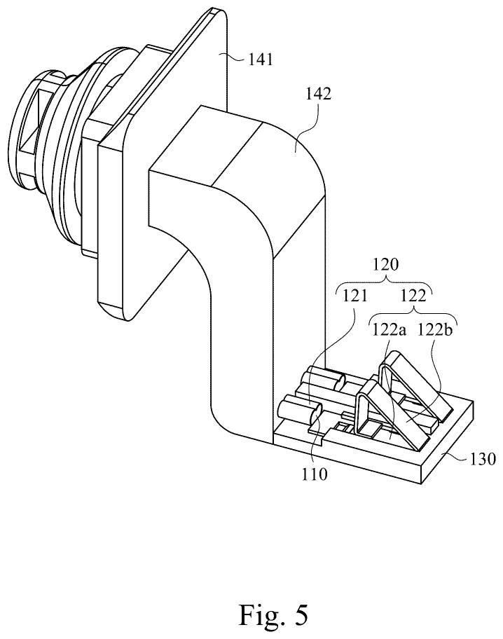

Reference is made to FIG. 5. FIG. 5 is another partial perspective view of some components of the cord assembly 100 in FIG. 1. As shown in FIG. 1 and FIG. 5, the cord assembly 100 further includes a cord sheath 140. The cord sheath 140 includes an inner mold 141 and an extending structure 142. The inner mold 141 covers a part of the conductive cord 110. The extending structure 142 is connected to the inner mold 141 and covers another part of the conductive cord 110 extending between the inner mold 141 and the terminal component 120 and a part of the base 130. In other words, except for the end crimped by the crimping portion 121, the portion of the conductive cord 110 extending away from the terminal component 120 is embedded in the cord sheath 140. In this way, the cord sheath 140 and the base 130 can work together to firmly maintain the relative position of the conductive cord 110 and the terminal component 120.

Furthermore, as shown in FIG. 1, the cord sheath 140 further includes an outer mold 143. The outer mold 143 covers a part of the inner mold 141, and covers a part of the conductive cord 110 further away from the terminal component 120 from the inner mold 141. The outer mold 143 forms a groove 140a with the inner mold 141. By making the extending structure 142 of the cord sheath 140 cover the conductive cord 110 and a part of the base 130 and making the cord sheath 140 have a specific shape, the terminal component 120 can be firmly positioned at a specific position in a housing 200 after the cord assembly 100 and the housing 200 are assembled. The positioning facilitates contact between the terminal component 120 and a welding material 320 on the circuit board 300 after subsequent assembly of the circuit board 300, which will be described in detail below.

In some embodiments, the inner mold 141 and the extending structure 142 include a first material. The outer mold 143 includes a second material. A hardness of the first material is greater than a hardness of the second material. In this way, the inner mold 141 and the extending structure 142 of the first material with the higher hardness can work together with the base 130 to firmly maintain the relative position of the conductive cord 110 and the terminal component 120, and the outer mold 143 of the second material with the lower hardness can allow the conductive cord 110 embedded therein to swing freely.

In some embodiments, the first material is a plastic with a greater hardness and the second material is a plastic with a smaller hardness. In actual manufacturing, the inner mold 141 and the extending structure 142 may be first wrapped around the conductive cord 110 and solidified to form using an insert molding process, and then the outer mold 143 may be wrapped around the inner mold 141 and solidified to form using an over-molding process.

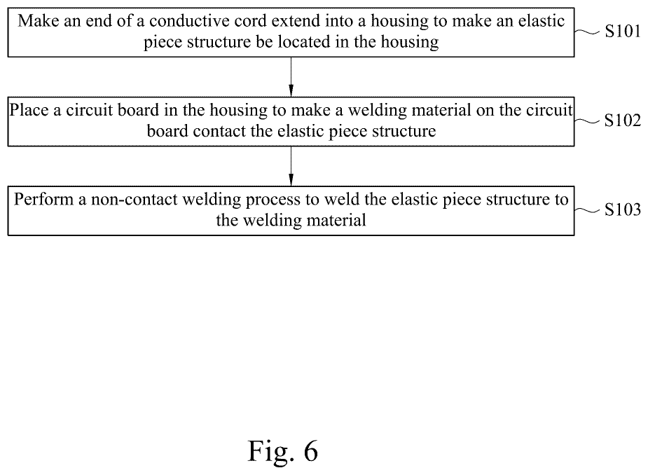

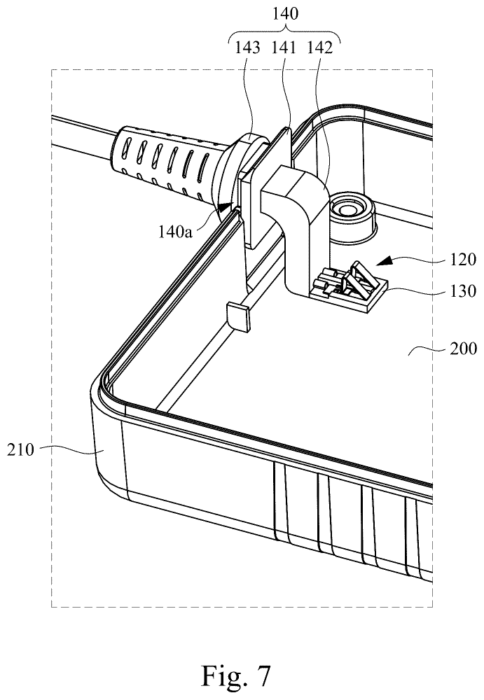

Reference is made to FIG. 6. FIG. 6 is a flowchart of an assembly method according to an embodiment of the present disclosure. The assembly method shown in FIG. 6 mainly includes steps S101 to S103, which are used to assemble the cord assembly 100 shown in FIG. 1 into the housing 200 shown in FIG. 7, for example. In some embodiments, the housing 200 is an appearance part of a power supply, but the disclosure is not limited thereto. As mentioned above, the cord assembly 100 includes the conductive cord 110 and the terminal component 120 connected to an end of the conductive cord 110. The terminal component 120 includes the elastic piece structure 122.

Step S101: Make an end of a conductive cord 110 extend into a housing 200 to make an elastic piece structure 122 be located in the housing 200.

Reference is made to FIG. 7. FIG. 7 is a schematic diagram of an intermediate stage of the assembly method according to an embodiment of the present disclosure. As shown in FIG. 7, the housing 200 includes a sidewall 210. In addition, as mentioned above, the cord assembly 100 includes the cord sheath 140 covering the conductive cord 110. Step S101 makes the extending structure 142 of the cord sheath 140 be located in the housing 200. Under the structural configurations, step S101 may include step S101a.

Step S101 a: place the cord sheath 140 on the sidewall 210 of the housing 200 so that a part of the sidewall 210 is engaged in the groove 140a between the inner mold 141 and the outer mold 143.

It can be seen that by making the extending structure 142 of the cord sheath 140 cover the conductive cord 110 and a part of the base 130 and making the cord sheath 140 have a specific appearance (i.e., the aforementioned groove 140a), the terminal component 120 can be firmly positioned at a specific position in the housing 200 after the cord assembly 100 and the housing 200 are assembled.

Step S102: place a circuit board 300 in the housing 200 to make a welding material 320 on the circuit board 300 contact the elastic piece structure 122.

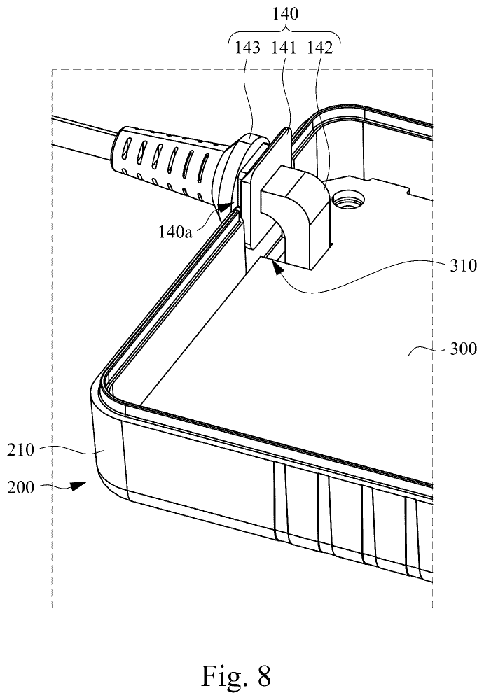

Reference is made to FIG. 8 and FIG. 9. FIG. 8 is a schematic diagram of another intermediate stage of the assembly method according to an embodiment of the present disclosure. FIG. 9 is a side view of the structure in FIG. 8, in which the housing 200 and the circuit board 300 are presented in cross-section. As shown in FIG. 8 and FIG. 9, the circuit board 300 can be placed into the housing 200 from top to bottom. There is the welding material 320 on a lower surface of the circuit board 300 to cover electrical contacts (not shown). In particular, an edge of the circuit board 300 has a notch 310. In addition, as mentioned above, the cord sheath 140 includes the extending structure 142. Under the structural configurations, step S102 makes the extending structure 142 of the cord sheath 140 enter the notch 310 of the circuit board 300. The notch 310 can be used as a clearance design to avoid structural interference with the extending structure 142 of the cord sheath 140 when the circuit board 300 is placed into the housing 200, and can also be used as a foolproof design during assembly.

Step S103: perform a non-contact welding process to weld the elastic piece structure 122 to the welding material 320.

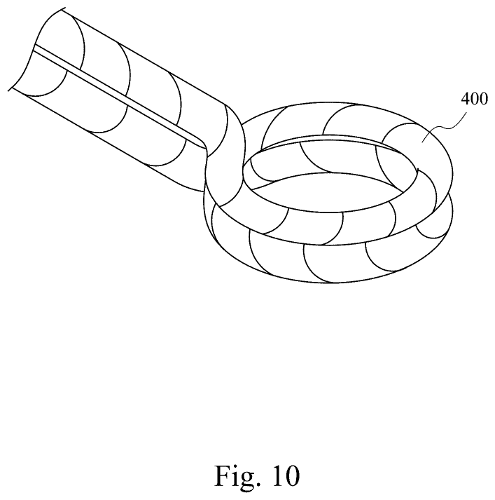

Reference is made to FIG. 10. FIG. 10 is a schematic diagram of an induction coil 400 according to an embodiment of the present disclosure. As shown in FIG. 9 and FIG. 10, the non-contact welding process is an electromagnetic induction welding process, and step S103 includes step S103a.

Step S103a: using an induction coil 400 to perform the electromagnetic induction welding process on the welding material 320 and the elastic piece structure 122 that are in contact with each other through the housing 200.

It should be noted that the electromagnetic induction welding process uses the principle of electromagnetic induction to heat metal workpieces (such as the welding material 320 on the circuit board 300 and the elastic piece structure 122) to reach a melting temperature, and then join them together after cooling. Its principle is briefly described as follows.

When an alternating current flows through the induction coil 400, an alternating magnetic field is generated around the induction coil 400. If the induction coil 400 is moved near the elastic piece structure 122, the elastic piece structure 122 will cut the magnetic field lines. According to Faraday's law of electromagnetic induction, an induced current, also known as eddy current, is generated in the elastic piece structure 122. The eddy current will flow in the elastic piece structure 122 and the welding material 320. Since metal has resistance, the eddy current will generate Joule heat in the elastic piece structure 122 and the welding material 320, causing the temperatures of the elastic piece structure 122 and the welding material 320 to increase. As the frequency of alternating current increases, the frequency of eddy currents also increases. The heat generated in the elastic piece structure 122 and the welding material 320 will also increase. When the temperature reaches the melting point of the welding material 320, the welding material 320 melts. In the molten state, the surfaces of the elastic piece structure 122 and the welding material 320 will fuse with each other. When the alternating current stops, the welding material 320 will cool and solidify, and form a strong welding structure with the elastic piece structure 122.

In practical applications, if there is enough space on a side of the circuit board 300 away from the housing 200 and an arrangement density of electronic components is not high, the induction coil 400 may be extended into the housing 200 and the electromagnetic induction welding process may be performed on the welding material 320 and the elastic piece structure 122 on the side of the circuit board 300 away from the housing 200.

It can be seen from this that compared with the conventional technology of first using SMT to dispose the terminal base and then manually connecting the DC power cord and the terminal base, the assembly method of the present embodiment can achieve the purpose of reducing the use of components and meet the needs of automated assembly.

According to the foregoing recitations of the embodiments of the disclosure, it can be seen that in the cord assembly and the assembly method using the same of the present disclosure, by crimping the crimping portion of the terminal component to an end of the conductive cord and engaging the terminal component and the base with each other, the terminal component can become an electrical connection structure that is firmly connected to the end of the conductive cord. By making the extending structure of the cord sheath cover the conductive cord and a part of the base and making the cord sheath have a specific shape, the terminal component can be firmly positioned at a specific position in the housing after the cord assembly and the housing are assembled. The positioning facilitates contact between the terminal component and the welding material on the circuit board after subsequent assembly of the circuit board. Finally, a non-contact welding process is used to weld the elastic piece structure and the welding material together, which can reduce the use of components and meet the needs of automated assembly.

Although the present disclosure is disclosed in the above embodiments, the embodiments are not intended to limit the present disclosure. Anyone skilled in the art can make various changes and modifications without departing from the spirit and scope of the present disclosure. Therefore, the protection scope of the present disclosure shall be determined by the appended claims.

What is claimed is:

1. A cord assembly, comprising:
a conductive cord;
a terminal component comprising:
a crimping portion crimped to an end of the conductive cord; and
an elastic piece structure comprising a first extending portion and a second extending portion, the first extending portion being connected to the crimping portion and extending away from the end of the conductive cord, the second extending portion being connected to an end of the first extending portion away from the crimping portion and folded relative to the first extending portion; and
a base having an engaging slot, wherein the first extending portion is engaged in the engaging slot, and the second extending portion protrudes outside the engaging slot.

2. The cord assembly of claim 1, wherein an edge of the first extending portion is slidably engaged with an inner edge of the engaging slot.

3. The cord assembly of claim 2, wherein the engaging slot has a side opening and a top opening, the first extending portion is configured to insert into the engaging slot from the side opening, and the second extending portion is configured to protrude outside the engaging slot from the top opening.

4. The cord assembly of claim 3, wherein a width of the side opening is greater than a width of the top opening.

5. The cord assembly of claim 4, wherein the first extending portion is configured to insert into the engaging slot in an insertion direction, and the width of the side opening and the width of the top opening are measured in a lateral direction perpendicular to the insertion direction.

6. The cord assembly of claim 3, wherein a width of the first extending portion is greater than a width of the second extending portion.

7. The cord assembly of claim 1, further comprising a cord sheath, the cord sheath comprising:
an inner mold covering a part of the conductive cord; and
an extending structure connected to the inner mold and covering another part of the conductive cord extending between the inner mold and the terminal component and a part of the base.

8. The cord assembly of claim 7, wherein the cord sheath further comprises an outer mold, and the outer mold covers a part of the inner mold and forms a groove with the inner mold.

9. The cord assembly of claim 8, wherein the inner mold and the extending structure comprise a first material, the outer mold comprises a second material, and a hardness of the first material is greater than a hardness of the second material.

10. An assembly method for assembling a cord assembly into a housing, the cord assembly comprising a conductive cord and a terminal component connected to an end of the conductive cord, the terminal component comprising an elastic piece structure, the assembly method comprising:
making the end of the conductive cord extend into the housing to make the elastic piece structure be located in the housing;
placing a circuit board in the housing to make a welding material on the circuit board contact the elastic piece structure; and
performing a non-contact welding process to weld the elastic piece structure to the welding material.

11. The assembly method of claim 10, wherein the non-contact welding process is an electromagnetic induction welding process.

12. The assembly method of claim 11, wherein the performing the non-contact welding process comprises:
using an induction coil to perform the electromagnetic induction welding process on the welding material and the elastic piece structure that are in contact with each other through the housing.

13. The assembly method of claim 11, wherein the performing the non-contact welding process comprises:
using an induction coil to perform an electromagnetic induction welding process on the welding material and the elastic piece structure on a side of the circuit board away from the housing.

14. The assembly method of claim 10, wherein the cord assembly further comprises a cord sheath, the cord sheath covers the conductive cord and has a groove, the housing comprises a sidewall, and the making the end of the conductive cord extend into the housing comprises:
placing the cord sheath on the sidewall so that a part of the sidewall is engaged in the groove.

15. The assembly method of claim 14, wherein the cord sheath comprises an extending structure, an edge of the circuit board has a notch, the making the end of the conductive cord extend into the housing makes the extending structure be located in the housing, and the placing the circuit board in the housing makes the extending structure enter the notch.
